(19) United States
(12) Patent Application Publication
(10) Pub. No.: US 2002/0033475 A1
(43) Pub. Date: Mar. 21, 2002

(54) Composition and method for separation of the different layers of long life packaging

(76) Inventors: Fernando Suarez Bejarano, Bogota (CO); Fabian E. Ortiz, Bogota (CO); Javier A. Ortiz, Bogota (CO); Alfonso Sanchez, Bogota (CO); Luis F. Sanchez, Bogota (CO); Gloria I. Nino, Bogota (CO)

Correspondence Address: ARENT FORX KINTNER PLOTKIN & KAHN, PLLC, Suite 600, 1050 Connecticut Avenue, N.W., Washington, DC, 20036-5339, US

(21) Appl. No.: 09/866,723

(22) Filed: May 30, 2001

Related U.S. Application Data
(60) Provisional application No. 60/208,066, filed on May 31, 2000.

(51) Int. Cl. B01F 1/00

(52) U.S. Cl. 252/364

(57) ABSTRACT

A composition and method for the separation of the different layers of long-life packaging includes an aqueous based synthetic treatment composition containing lactic acid, sodium acetate, cellulase enzymes, α-amylase enzymes, maltose enzymes, citric acid and activated carbon.

Applicants claim the benefit of co-pending U.S. provisional patent application Serial No.60/208,066 filed May 31, 2000, the subject matter of which is incorporated herein by reference in its entirety.

### BACKGROUND OF THE INVENTION

1. Filed of Invention

The invention is directed to a composition and process for the separation of long-life packaging material that is composed of several layers, enabling the recycling all the components, and enabling use of the individual layers as raw material for the paper, plastics, aluminum and related industries.

2. Background and Prior Art

The market for packaging of juices, milk products, wine and the like has shifted towards long life packaging that uses ultra-pasteurized materials, commonly referred to as TetraPak®, but also produced by other similar packaging producers such us Elopak, International Paper. These packaging systems provide for excellent preservation of the contents contained in the packaging at a low cost for a long period of time.

These types of packaging are typically composed of a multilayer sheet material including a plurality of various layers, which can include: cardboard, paper, aluminum foil and low-density food grade plastics.

Process for manufacturing TetraPak® and use thereof.

The process for manufacturing Tetra brik aseptic packaging consists in joining seven(7) layers from three different materials(paper, polyethylene, and aluminum). These layers have a specific arrangement, they are exposed to a thermal lamination after having been put one layer on top of the other layer. This process allows that the different layers are adhered to each other (Becerra,1997). Packaging printing is carried out on one of polyethylene layers with inks on the basis of water and it is covered with another polyethylene layer.

According to the foregoing, the aseptic packaging Tetra brik is composed of the follows layers: 4 layers of polyethylene, 2 layers of paper and 1 layer of aluminum.

This packaging has been developed for preserving ultra-pasteurized liquid food and they must guarantee conditions of strict asepsis. Thus, this packaging has the following characteristics:

It is opaque, waterproof and gas proof. It does not produce any taste or odor, resist to thermal and chemical pretreatment, and light. Moreover, it is a slow process and easy to be carried out. The composition of these packaging, specially the aluminum sheet, eliminates the need to refrigerate food, what represents a save energy for the consumer.

Currently, the use of this packaging has been extended, it is now also used for the packaging of food such us dairy products, wines, juices, soups among other.

Due to its composition, this type of packaging faces problems for disposal, since it is low biodegradable. Currently, this problem has increased due to the increase of the consumption of food packaged with tetraPak aseptic®.

Methods for Tetra brik aseptic® packaging treatment.

There are some recycling techniques used for this packaging. The most common one is to use it as a combustible for boilers, which transform the disposal in energy.

This type of treatment needs a special filters for removing the high quantity of sulfur that can be emitted in the environment. (it is known that this packaging may have 10% of S).

Another technique is to use the packaging waste in the manufacture of brick sheets of different sizes. After cutting and pressing the packaging waste at a high temperature these sheets are obtained. They are used to replace bricks of wood.

As it is shown in the above mentioned methods, they are developed for using the used packaging without changing its physical structure.

Previously, it has not been possible to perfectly separate all of the layers of the long-life packaging, which has resulted in the inability to fully recycle all of the materials from these types of packaging. This inability to fully recycle the materials leads to pollution problems, including the saturation of landfills where non-recycled materials are ultimately collected.

It is known from the prior art, that two methods related to the separation of the different layers of the packaging, enable recycled use of the individual layers. These methods are described bellow:

U.S. Pat. No. 5,390,860 to Ali et al., for a Method and Apparatus for Separating Paper Fiber and Plastics from Mixed Waste Materials and Products Obtained Thereby, describes the separation of fiber and plastic components in a wet environment, using equipment such as a depulper, centrifuge, mill, separators, filters, shakers, sedimentation tank, pulverizer etc. The Ali et al. System requires the use of sophisticated and expensive equipment, which through an aqueous medium permits the separation of the fibers.

ES Patent No.2124189 Al as well as EP Patent No. 543302, describe the separation of the different layers by using an aqueous acetic acid solution under high temperatures during about 1 to 5 days, this period depends of the concentration of the acetic acid in the solution. This process has some disadvantages such as being slow which can produce hazardous vapors and it also requires a high demand of physical, technical and economical resources.

The most used method in an industrial environment is the hydrodepulper but it has the disadvantage of consuming a lot water and expensive in equipment. It is known that countries like Mexico, Brazil, Canada, etc use this technique.

### SUMMARY OF THE INVENTION

After extensive research, new compositions have been identified and tested which permit the substantially complete separation of all of the layers of materials in long-life packaging.

The new aqueous composition separates six(6) of the seven(7) layers that comprise the Tetra brik aseptic. Only two of the layers which contain the ink used for printing the packaging continue joined to each other.

The subject matter of this invention can provide the following advantages in comparison to the present state of the art for separating the layers of long-life packaging materials:

1. Waste material which was previously not economically feasible to fully recover can now be perfectly separated into individual layers and used in different processes;

2. The process leading to the separation is organic and does not harm the environment;

3. The financial investment necessary is minimal, leading to an economical and rapid separation of all materials;

4. The water consumption is part of a closed loop system, eliminating the need for waste water treatment;

5. The separation process does not remove ink from the print on the packaging, eliminating the need for waste management due to ink particles suspended in the water.

### DETAILED DESCRIPTION OF THE PREFERRED EMBODIMENTSOF THE INVENTION

The present invention relates to a simple process of separating the layers of long-life packaging Tetra brik aseptic which starts with the preparation of a synthetic composition.

Taking into account some of the main compounds contained in the packaging, the composition was formulated.

After watching the packaging waste for a period of time, it was found that in some spots of the packaging, there was a separation of the different layers. From this observation, different formulations were tested including the compounds found in food such us dairy products, wines, juices, among other. Thus, by the method of test and error it was found a formulation which enables the separation of long-life packaging material (Tetra brik aseptic®).

An exemplary embodiment of the formulation can include lactic acid, sodium acetate, enzymes such as cellulase, α-amylase and maltose, citric acid, activated carbon and/or water.

Exemplary embodiments of the aqueous treatment formulation will have from about 5-10% by volume lactic acid, 20-40% by volume sodium acetate, 5-20% by volume cellulase enzymes, 5-20% by volume α-amylase enzymes, 5-20% by volume citric acid, 0-5% activated carbon, with the remainder being water.

A particularly preferred exemplary treatment composition is shown in the table below

Preferred Exemplary Composition (% by volume)

| | |
|---|---|
| Lactic acid | 5-10% |
| Sodium acetate 1N | 25-35% |
| Enzymes: | |
| cellulases | 10% |
| α-amylase | 10% |
| Citric acid (only at 10%) | 15-25% |
| Activated carbon | 2% |
| pH | 3-4 |
| Water | 20-10% |

In illustrative embodiments of the process for treatment packaging materials, a packaging material having a size of 15×22.7 cm, one liter content, with residual liquid contained inside, can be treated with the formulation of this invention.

The long-life packaging to be treated will generally be composed of a paper or paperboard layer or layers and a film layer or layers of a plastic or metallized material. While the packaging will normally include at least these two types of layers, there is no limit to the number of dissimilar (or similar) layers that can be separated in accordance with the invention.

The mixture of the invention was called synthetic composition. The reaction conditions of this formulation was determined by the variation of parameters such as pH and temperature. It was found a formulation enabling to separate into six individual layers the packaging, with a pH parameter between 3.0 and 4.0, a temperature parameter between 70° C. and 90° C. and continious stirring. The six layers are as follow: two layers of paper, three layers of polyethylene (one of these layers included the print of the packaging) and one layer of aluminum. Using acetic acid the pH of the formulation can be set up according to the established range, when needed.

The packaging material can be introduced into the mixture of this invention, for example, for about 3-10 minutes or more, and preferably for about 5 minutes, at a temperature of, for example, about 70-90° C. or more, and preferably about 80° C.

After the packaging material has been introduced into the treatment composition, the mixture becomes enriched with the food residues from the packaging material. Calcium carbonate can be added to the mixture.

Treatment of the packaging materials and the contained food residues with the enzyme containing synthetic treatment medium at an effective temperature produces a reformulation of the mixture such that it includes:

Acetic acid

Lactic acid

Buthanol

Ethanol

Enzymes and

Citric Acid

In embodiments of the process of this invention, this mixture is preferably purified using actived carbon.

The final formula can be put into a container at a temperature of about 80° C., and held in the container at that temperature. The long life packaging is introduced for about 5 minutes, after which the packaging layers are separated without polluting the environment.

### EXPERIMENTAL RESULTS

Different test were carried out with Tetra brik aseptic packaging of different sizes (250 ml, 500 ml and 1l), which were used to pack juices, milk, wine, among other.

A total of 450 packages are treated in accordance with the invention. First, 18 long life packages composed of a plurality of layers, each having a size of 8×6 cm, 3 of which contain juice residues, 2 contain milk residues, 4 contain wine residues and the rest contain yogurt are tested. The 450 packaging is cut into square shape pieces. After that, they are introduced into the exemplary synthetic medium of this invention for 5 minutes at 80° C., with a pH between 3 and 4 and constant stirring. Then the enriched synthetic medium passes to a container.

As a result, it was obtained 900 paper layers, 450 aluminum layers and 1350 polyethylene layers, which do not contain any residues of the adjacent layers

The components of the enriched medium produced after treatment with the preferred exemplary formulation (%by volume) of this invention include:

| | |
|---|---|
| Water | 25% |
| Acetic acid | 21% |
| Buthanol | 19% |
| Lactic acid | 18% |
| Ethanol | 10% |
| Enzymes | 5% |
| Acid residues and inert substances | 2% |

The enriched solution is introduced into the containers and the long life packaging is introduced into this solution for 5 minutes. Test are run for 2 hours, and another 432 packages are separated into 2592 layers, separated into different parts, unspoiled and without any organic residue.

The formulation for the separation of packaging layers is possible due to the pretreatment and enrichment process of the mixtures.

A preferred exemplary synthetic formula (% by volume) for preparing the formulation is

| | |
|---|---|
| Lactic acid | 6% |
| sodium acetate | 30% |
| Enzymes: | |
| cellulases | 10% |
| α-amylase | 10% |
| citric acid | 12% |
| Activated carbon | 2% |
| Water | 30% |
| PH | 3-4 |

The formula and the enrichment process preferably include calcium carbonate, with formula being purified with activated carbon prior to its use as a separator. Additionally, the enzymes can, in embodiments, also include maltose.

The formula is introduced into a container at about 80° C., the packaging is submersed for about 5 minutes, enabling the various layers of the packaging material to separate completely.

What is claimed is:

1. An aqueous composition for separating layers of long-life packaging, comprising:
5-10% by volume lactic acid;
20-40% by volume sodium acetate;
5-20% by volume cellulase enzymes;
5-20% by volume α-amylase enzymes;
5-20% by volume citric acid;
0-5% by volume activated carbon; and
the remainder comprising water.

2. The aqueous composition of claim 1, comprising:
6% by volume lactic acid;
30% by volume sodium acetate;
10% by volume cellulase enzymes;
10% by volume α-amylase enzymes;
12% by volume citric acid;
2% by volume activated carbon; and
30% water.

3. A method of separating the layers of long-life packaging, comprising: contacting long-life packaging, comprising a plurality of layers that differ in at least two physical and chemical properties, with the composition of claim 1;
separating each of the plurality of layers; and
separately recovering each of the plurality of layers.

4. The method of claim 3, further comprising recycling each of the plurality of layers.

5. The method of claim 3, wherein the contacting produces an enriched mixture comprising about 25% water, about 21% acetic acid, about 19% Buthanol, about 18% lactic acid, about 10% ethanol, about 5% enzymes, and about 2% acid residues and inert substances.

6. The aqueous composition of claim, further comprising maltose enzymes.
